(19) United States
(12) Patent Application Publication
(10) Pub. No.: US 2012/0120879 A1
(43) Pub. Date: May 17, 2012

(54) GATEWAY DEVICE, DATA CONVERTING METHOD, AND PROGRAM

(76) Inventor: Kazunori Ozawa, Tokyo (JP)

(21) Appl. No.: 13/383,379

(22) PCT Filed: Jul. 15, 2010
(86) PCT No.: PCT/JP2010/061990

§ 371 Date: Jan. 10, 2012

(30) Foreign Application Priority Data
Jul. 21, 2009 (JP) 2009-170016

(51) Int. Cl. H04W 4/00

(52) U.S. Cl. 370/328

(57) ABSTRACT

A gateway device includes a control signal conversion unit that accepts a stream or file request message from a mobile terminal via a femtocell access point and, after performing predetermined conversion, forwards the request message to a request destination; an ability table in which ability information on various types of mobile terminal is stored; a packet reception unit that receives a stream or a file from the request destination; a conversion instruction unit that determines a way of conversion according to ability information on the mobile terminal of a request source by referencing the ability table; a conversion unit that performs conversion for the stream or the file, received from the request destination, according to the way of conversion; and a packet transmission unit that transmits the converted stream or file to the mobile terminal.

### TECHNICAL FIELD

### DESCRIPTION OF RELATED APPLICATION

The present invention claims priority from Japanese Patent Application 2009-170016 (filed on Jul. 21, 2009) the content of which is hereby incorporated in its entirety by reference into this specification.

The present invention relates to a gateway device, a data converting method, and a computer program, and more particularly to a gateway device, a data converting method, and a computer program for transmitting content on the Internet or other networks to a mobile terminal when a request is received from the mobile terminal that is in the cell of a femtocell access point installed in a home.

### BACKGROUND

With the increase in the mobile network speed, a femtocell access point (also called a “very small base station” to indicate that the cell is relatively smaller than that of an existing base station or small base station) has been developed for use in a home for connection to a mobile IMS (IP Multimedia Subsystem) network to carry out communication with a mobile terminal in the home. The femtocell access point, when connected to a gateway on a mobile IMS network, allows downlink data to be delivered from a delivery server on the Internet or NGN (Next Generation Network), which has very heavy traffic, to a mobile terminal not via a bandwidth-limited mobile radio network. Therefore, communication carriers are expected to install more and more femtocell access points in future. As a femtocell access point, Home NodeB, as well as Home eNodeB capable of forwarding a larger amount of data at a higher speed, are now under development.

Today, an end user can receive content, which includes video and audio, in a home using IPTV (Internet Protocol Television) via a broadband network or an NGN. In future, an end user will be able to receive content not only via TV but by a mobile terminal in a home via a femtocell access point.

Patent literature 1 discloses an AV gateway device that operates as follows when the user of a viewing terminal, connected to the network, views content. The AV gateway notifies the viewing terminal about the delivery content, stored in a delivery server connected to the network, as the content the AV gateway device itself has. When the viewing terminal issues a request to acquire the delivery content, the AV gateway acquires the delivery content corresponding to the request received from the viewing terminal, converts the viewing content to a format receivable by the viewing terminal, and transmits the converted content to the viewing terminal.

Patent Literature 2 discloses an information management server that includes a profile unit. When a mobile terminal (UE) acquires content, this profile unit generates profile information, composed of user agent information on the mobile terminal, user information (User-Profile), self-care information (Selfcare-Profile), and mobile terminal information (UE-Profile), and transmits the generated profile information to an application gateway. The information management server converts the content, acquired from the origin server in response to a content requesting request (HTTP Req) transmitted from the mobile terminal, by referencing the parameters indicating the performance and ability of the mobile terminal included in the profile information so that the performance and the ability of the mobile terminal can be fully utilized.

### Patent Document 1:

Japanese Patent Publication Kokai Publication JP2003-271487A

### Patent Document 2:

Japanese Patent Publication Kokai Publication JP2005-275534A

### SUMMARY

The disclosure of the Patent Literatures given above is hereby incorporated in its entirety by reference into this specification. The following analysis is given from a viewpoint of the present invention.

The video and audio decoding and reproduction ability of a mobile terminal (that is, a mobile phone, a PHS, a mobile data card built-in notebook PC, and a mobile data card built-in game machine) for receiving content, which includes video and audio, via the femtocell access point described above differs greatly among the terminals. Therefore, if video and audio content delivered from a delivery server, a web server, or IPTV is not compatible with the ability of a mobile terminal in terms of at least one of the codec, screen size, bit rate, protocol, and file format, the problem is that the mobile terminal cannot decode or display the content.

For example, content delivered by services such as IPTV, created originally for reproduction and display on a TV screen, cannot be directly reproduced or displayed on a mobile terminal in a home via a femtocell access point if an attempt is made to deliver the content to the mobile terminal.

The AV gateway device disclosed in Patent Literature 1 does not have the function to perform conversion according to various types of mobile terminal. The information management server disclosed in Patent Literature 2 provides services for the subscribers of a particular mobile communication carrier. Therefore, when a mobile terminal requests the origin server to transmit content that matches the performance and ability of the mobile terminal but the content that matches the performance and the ability of the mobile terminal cannot be acquired, the information management server performs transcoding only.

According to a first aspect of the present invention, there is provided a gateway device, comprising a control signal conversion unit that accepts a stream or file request message from a mobile terminal via a femtocell access point and, after performing predetermined conversion, forwards the request message to a request destination; an ability table that stores ability information on various types of mobile terminals; a packet reception unit that receives a stream or a file from the request destination; a conversion instruction unit that determines way of conversion according to ability information on the mobile terminal of a request source by referencing the ability table; a conversion unit that performs conversion for the stream or the file, received from the request destination, according to the way of conversion; and a packet transmission unit that transmits the converted stream or file to the mobile terminal.

According to a second aspect of the present invention, there is provided a data relay method, comprising: accepting a stream or file request message from a mobile terminal via a femtocell access point and, after performing predetermined conversion, forwarding the request message to a request destination; receiving a stream or a file from the request destination; determining way of conversion according to ability information on the mobile terminal of a request source by referencing an ability table that stores ability information on various types of mobile terminals; performing conversion for the stream or the file, received from the request destination, according to the way of conversion; and transmitting the converted stream or file to the mobile terminal. This method is associated with a particular machine called a gateway device that accepts a stream or file request message from a mobile terminal, performs predetermined conversion for the request message and transmits it to a request destination, and forwards a stream or a file, transmitted from the request destination, to the mobile terminal.

According to a third aspect of the present invention, there is provided a computer program that causes a computer, connected to a femtocell access point, to perform processing of, accepting a stream or file request message from a mobile terminal via a femtocell access point and, after performing predetermined conversion, forwarding the request message to a request destination; receiving a stream or a file from the request destination; determining a way of conversion according to ability information on the mobile terminal of a delivery request source by referencing an ability table that stores ability information on various types of mobile terminals; performing conversion for the stream or the file, received from the request destination, according to the a way of conversion; and transmitting the converted stream or file to the mobile terminal. This program may be recorded on a computer readable storage medium. That is, the present invention may be implemented as a computer program product.

The meritorious effects of the present invention are summarized as follows.

According to the present invention, the user can view video and audio content, via a femtocell access point, using any mobile terminal without worrying about the ability and the type of the mobile terminal.

### BRIEF DESCRIPTION OF THE DRAWINGS

FIG. 1 is a diagram showing the outline of an exemplary embodiment of the present invention.

FIG. 2 is a diagram showing the connection configuration of a first exemplary embodiment of the present invention.

FIG. 3 is a diagram showing the configuration of a gateway device in the first exemplary embodiment of the present invention.

FIG. 4 is a diagram showing the connection configuration of a second exemplary embodiment of the present invention.

### PREFERRED MODES

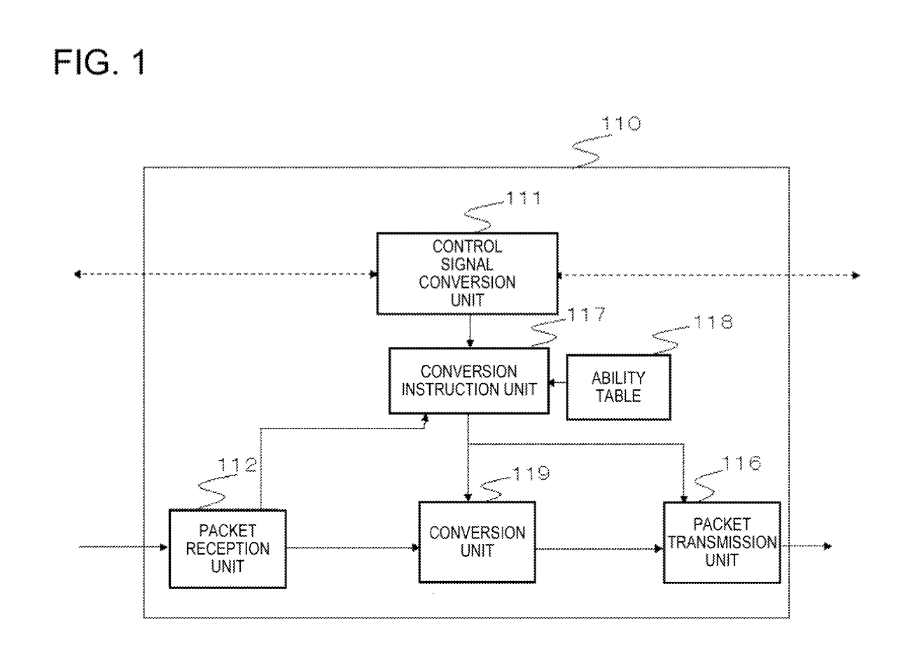

Next, the following describes the outline of an exemplary embodiment of the present invention with reference to the drawings. Note that the drawing reference numerals used in this outline are attached to the elements to help understand the present invention but are not intended to limit the present invention to the modes shown in the figures. As shown in FIG. 1, a gateway device 110 of the present invention includes a control signal conversion unit 111 that accepts a request message for a stream or a file from a mobile terminal via a femtocell access point, performs predetermined conversion for the message, and forwards the converted message to the request destination; an ability table 118 that stores ability information on two or more types of mobile terminals selected in advance from a mobile phone, a PHS, a mobile data card built-in notebook PC, and a mobile data card built-in game machine; a packet reception unit 112 that receives a stream or a file from the request destination; a conversion instruction unit 117 that references the ability table to determine the way of conversions according to the ability information on the mobile terminal at the request source; a conversion unit 119 that converts the stream or file, received from the request destination, according to the way of conversion; and a packet transmission unit 116 that transmits the converted stream or file to the mobile terminal.

When a request is received from a mobile terminal in the service area of a femtocell access point installed in a home, the gateway device 110 reads a stream or a file, which includes at least one of video and audio, from the request destination (delivery server, content server, or web server on the Internet, NGN, or other networks) and performs conversion for the stream or the file according to the way of conversion corresponding to the machine type or the ability information on the mobile terminal stored in the ability table. In addition, the gateway device 110 converts the stream or file according to the protocol of the access point of the femtocell and then transmits the stream or file to the mobile terminal.

The gateway device with the above configuration allows the mobile terminal of a pre-selected type, such as a mobile phone, a PHS, a mobile data card built-in notebook PC, and a mobile data card built-in game machine, to receive content via the femtocell access point in a home and to reproduce/display it.

### First Exemplary Embodiment

Next, a first exemplary embodiment of the present invention will be described in detail below with reference to the drawings. Although moving image content is delivered in an example of this exemplary embodiment, a similar configuration may also be used to deliver a still image, audio, and voice.

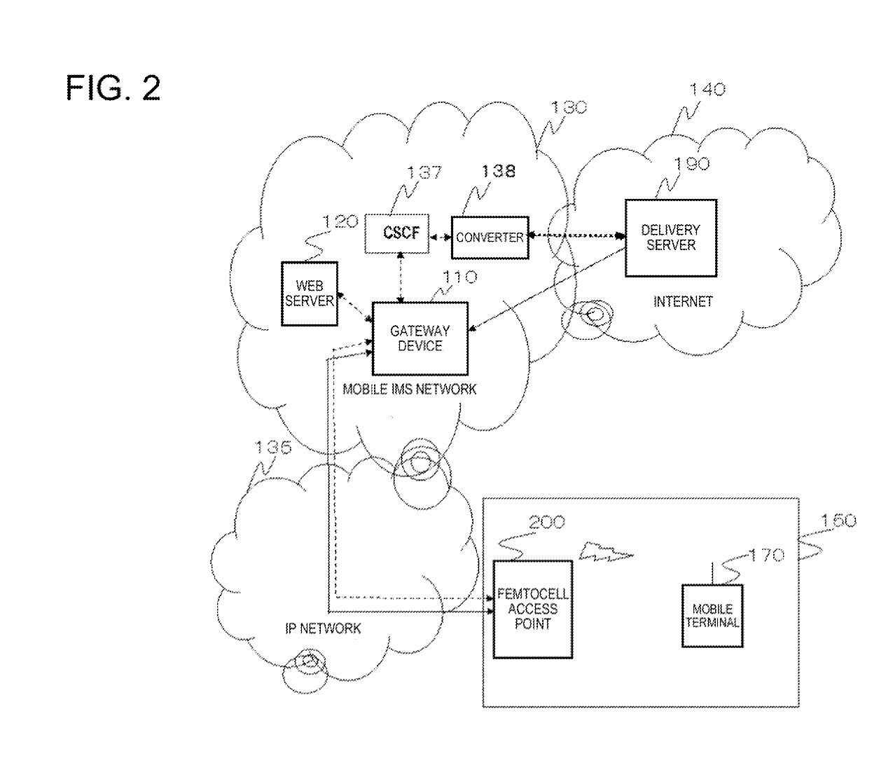

FIG. 2 is a diagram showing the connection configuration of the first exemplary embodiment of the present invention. In the figure, the solid-line arrow represents the flow of data, while the broken-line arrow represents the flow of control signals. The reference numeral 150 in FIG. 2 indicates the home of the user (hereinafter called “home 150”) of a mobile terminal 170. A femtocell access point 200, installed in the home 150, is wirelessly connectable to nearby mobile terminals 170 in the femtocell service area.

The femtocell access point 200 is connected to an IP (Internet Protocol) network 135 in the area and connected to a mobile IMS network 130 via the IP network 135. The network 130 may be a BB (Broadband network), an NGN (Next Generation Network), or the Internet. In the description below, the mobile IMS network 130 is assumed to be a BB (Broadband Network).

A gateway device 110 is installed on the mobile IMS network 130 and is connected to the femtocell access point 200 in the home via the IP network 135.

The mobile terminal 170 connected to the femtocell access point 200 for receiving video content may be one of the various terminals such as a mobile phone, a PHS, a mobile data card built-in notebook PC, and a mobile data card built-in game machine. In the description below, a mobile phone is used.

The mobile terminal 170 connects to the femtocell access point 200 for authentication by a web server 120. For example, to view content provided by a delivery server 190 on the Internet 140 after successful authentication, the user performs the operation to select the desired content from the content selection screen provided by the web server 120.

The web server 120 performs the authentication processing in response to the authentication request from the mobile terminal 170. After successful authentication, the web server 120 outputs the authentication success notification and the content selection result, accepted from the user of the mobile terminal 170, to the gateway device 110 and, at the same time, notifies the reception IP address of the gateway device 110 to the mobile terminal 170. After that, the mobile terminal 170 outputs a connection request to the femtocell access point 200, which outputs the connection request to the gateway device 110.

In this exemplary embodiment, the protocol used by the mobile terminal 170 to output the connection request is HTTP (Hyper-Text Transfer Protocol) on TCP (Transmission Control Protocol)/IP (Internet Protocol). Instead, SIP (Session Initiation Protocol) may also be used.

When HTTP is used, the mobile terminal 170 may output a request command to make a connection request. The gateway device 110 converts the request command of HTTP, for example, to the Invite message of SIP and transmits the message to CSCF (Call Session Control Function) 137.

The CSCF 137, a device corresponding to a SIP server, receives the Invite message and transmits it to a converter 138.

The converter 138, a device that performs conversion between SIP and RTSP (Real Time Streaming Protocol), converts the SIP message, for example, to the RTSP Setup command and transmits it to the delivery server 190.

The delivery server 190 receives the RTSP Setup command and delivers the file or stream, in which the requested video content is stored, to the gateway device 110.

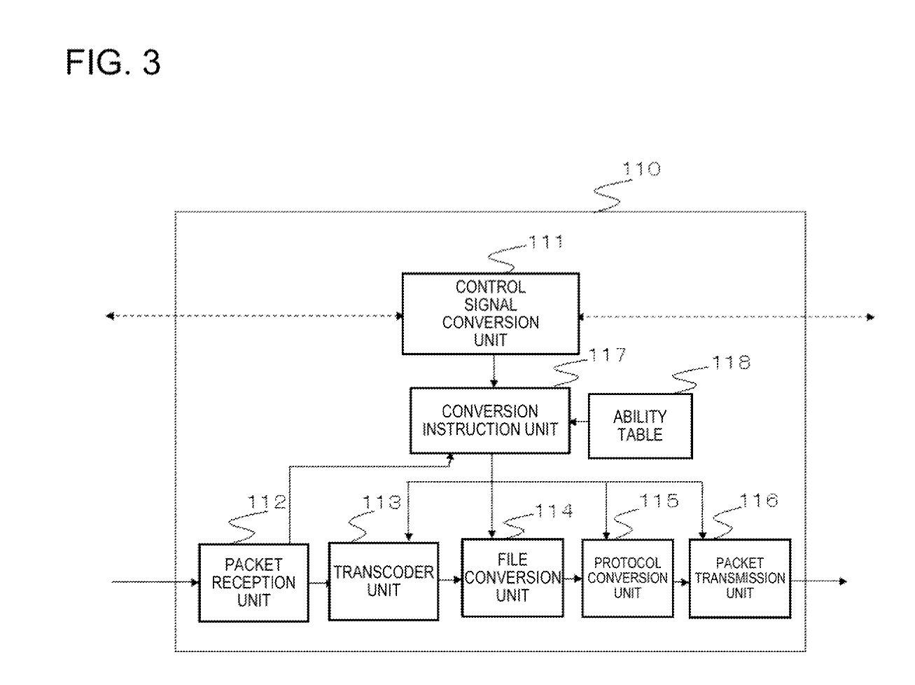

Next, the following describes the configuration of the gateway device 110 in detail with reference to the drawings. FIG. 3 is a diagram showing the configuration of the gateway device in the first exemplary embodiment of the present invention.

FIG. 3 shows the gateway device 110 that includes a control signal conversion unit 111, a packet reception unit 112, a transcoder unit 113, a file conversion unit 114, a protocol conversion unit 115, a packet transmission unit 116, a conversion instruction unit 117, and an ability table 118.

The control signal conversion unit 111 receives the authentication completion notification and the content selection result from the web server 120 and receives an HTTP request command, transmitted by the mobile terminal 170, from the femtocell access point 200 as a GTP-C (General packet radio Service Tunneling Protocol C-Plane) packet.

The control signal conversion unit 111 retrieves the HTTP request command, stored in the payload field of the GTP-C packet, and reads the terminal type information, included in the user agent header of the HTTP request command, to identify the terminal type of the mobile terminal 170. For example, the terminal type information includes information on the mobile phone manufacturer, type, and so on. The control signal conversion unit 111 outputs the terminal type information to the conversion instruction unit 117.

On the other hand, the control signal conversion unit 111 converts the HTTP request command, stored in the GTP-C packet received from the femtocell access point 200, for example, to the SIP (Session Initiation Protocol) Invite message and transmits it to the CSCF (CSCF 137 in FIG. 2).

The packet reception unit 112 receives the file or stream, corresponding to the requested video content, from the delivery server 190 on the Internet 140, extracts the stream stored in the file, and outputs the extracted stream to the transcoder unit 113. In addition, the packet reception unit 112 reads content information (for example, video compression encoding method, video screen resolution, bit rate, frame rate, video content time length, audio compression encoding method, audio content time length, and so on), stored in the content file, and outputs it to the conversion instruction unit 117.

The conversion instruction unit 117 reads the ability information on the machine type, corresponding to the terminal type information received from the control signal conversion unit 111, from the ability table 118 and, based on this ability information and the content information received from the packet reception unit 112, determines what conversion the transcoder unit 113 is to perform.

The ability table 118 stores the following ability information on each machine type of the mobile terminal 170 in advance: (1) Allowable codec, (2) Screen resolution, (3) Frame rate, (4) Receivable file format and file size, and (5) Reception protocol.

For example, assume that the content information is output indicating that the video content delivered from the delivery server 190 is compression encoded with MPEG-2 MP (Main Profile) at 8 Mbps, that the screen resolution is SD (720×480 pixels), and that the frame rate is 30 fps. Also assume that that the terminal type information is output indicating that the mobile terminal 170 is a new-type mobile phone.

On the other hand, assume that the ability information is obtained from the ability table 118 indicating that the terminal processes content encoded with H.264 at 512 kbps, that the screen resolution is QVGA (320×240 pixels), and that the frame rate is 30 fps. In this case, the conversion instruction unit 117 creates the way of conversion for converting content so that it is compatible with the ability information on the terminal (for example, content is decoded with MPEG-2 MP, the screen resolution is converted from SD to QVGA, and the content is encoded with H.264 at 512 kbps with the frame rate of 30 fps) and outputs the created way of conversion to the transcoder unit 113. In addition, the conversion instruction unit 117 outputs the ability information, which has been read, to the file conversion unit 114, protocol conversion unit 115, and packet transmission unit 116.

The transcoder unit 113 receives the stream extracted from the packet reception unit 112, receives the way of conversion described above from the conversion instruction unit 117 (for example, the stream is decoded with MPEG-2 MP, the screen resolution is converted from SD to QVGA, and the stream is encoded with H.264 at 512 kbps with the frame rate of 30 fps), causes the transcoder, which operates in real time, to operate according to the way of conversion to perform conversion for the stream (for example, the received stream is decoded with MPEG-2 MP, the screen resolution is converted from SD to QVGA, and the stream is encoded with H.264 at 512 kbps with the frame rate of 30 fps), and outputs the converted stream to the file conversion unit 114.

The file conversion unit 114 receives the ability information on the mobile terminal 170 from the conversion instruction unit 117, receives the converted stream from the transcoder unit 113, and converts the stream to a file format suitable for transmission to the mobile terminal 170 via the femtocell access point 200 according to the ability information. The file format is, for example, 3GPP, 3GPP2, MP4, etc., which depends on the file format allowable for the type of the mobile terminal. The file conversion unit 114 determines which file format to use according to the ability information, generates a file according to the determined file format, stores the converted stream in the file, and outputs the file to the protocol conversion unit 115. For the details of the 3GPP file format, see the 3GPP TS26.244 standard.

The protocol conversion unit 115 receives the ability information from the conversion instruction unit 117, determines the protocol via which the femtocell access point 200 will be able to receive the file and, via this protocol, transmits the file, received from the file conversion unit 114, to the packet transmission unit 116. In the description below, GTP-U (GPRS Tunneling Protocol U-Plane) via the Iu-h interface is used as the protocol. The protocol conversion unit 115 reads the file format using the GTP-U/UDP/IP protocol and outputs it to the packet transmission unit 116. For the specifications of the Iu-h interface and the GTP-U protocol, see 3GPP standard TS25.467 v8.0.0.

The packet transmission unit 116 receives the ability information from the conversion instruction unit 117, receives the protocol and the file format from the protocol conversion unit 115 and, via the IP network 135, transmits the GTP-U/UDP/IP packet to the femtocell access point 200 via the Iu-h interface.

As shown in FIG. 2, the femtocell access point 200 receives a packet via the Iu-h interface, converts the packet for transmission via the Uu interface defined for radio transfer, and wirelessly transmits the packet to the mobile terminal 170.

The mobile terminal 170 receives the content file, stored in the packet, from the femtocell access point 200 via the Uu interface, retrieves the stream from the file, and decodes, reproduces, and displays the stream.

As described above, the present invention allows the content to be decoded and displayed without having to modify various types of mobile terminal in the home 150 (for example, mobile phone, PHS, mobile data card built-in notebook PC, and a mobile data card built-in game machine). The reason is that the gateway device 110 shown in FIG. 3 is configured as follows. That is, the gateway device 110 converts content, which includes video stored in a delivery server on the Internet or NGN, or content, which is supplied by the IPTV service for playback and display on TV, so that the content becomes compatible with the ability information on the mobile terminal 170 used for viewing and, after that, delivers the converted content to the femtocell access point 200.

### Second Exemplary Embodiment

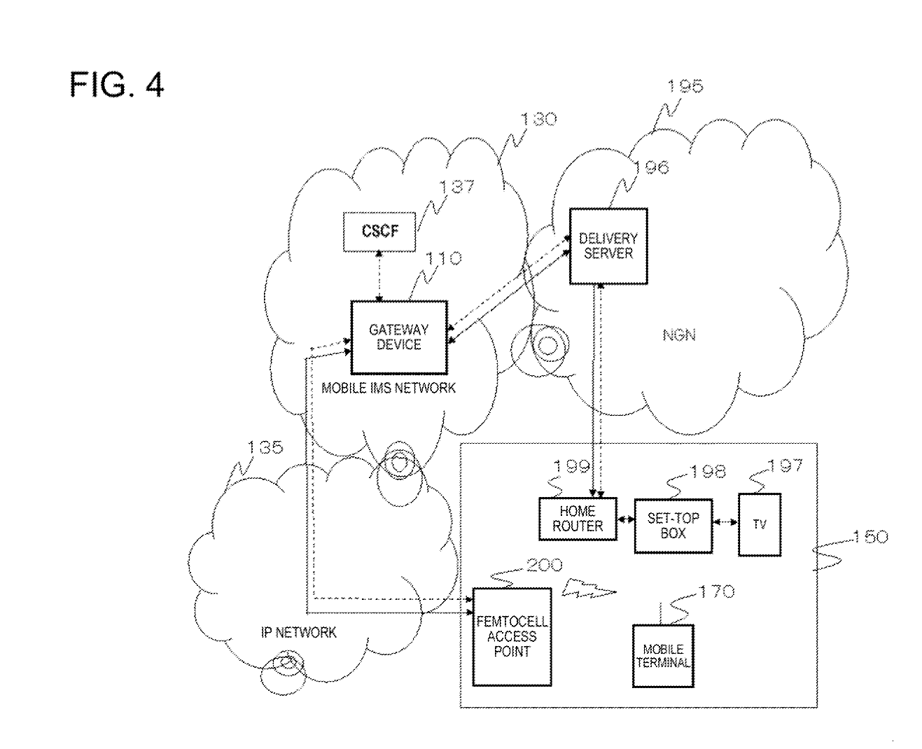

Next, a second exemplary embodiment of the present invention will be described below in which a delivery server 196 is an IPTV broadcast server on the NGN. FIG. 4 is a diagram showing the connection configuration of the second exemplary embodiment of the present invention. In FIG. 4, the components with the reference numerals already used in FIG. 2 perform the operations corresponding to those in the first exemplary embodiment and therefore the description is omitted. The following describes the difference.

The delivery server 196, installed on an NGN 195, functions as an IPTV server that provides the IPTV broadcast service via the NGN 195. That is, the delivery server 196 delivers IPTV content, which includes video and audio, via the NGN 195.

The delivered content is received by a home router 199 in the home 150, decoded by a set-top box 198, and displayed on a television set (TV) 197.

In the above configuration, too, when the mobile terminal 170 requests the gateway device, via the femtocell access point 200, to transmit the same video/audio content as that available on the IPTV service, the gateway device 110 on the mobile IMS network 130 converts the content for display on the mobile terminal 170 as in the first exemplary embodiment described above and, after that, transmits the converted content to the femtocell access point 200 installed in the home 150. The mobile terminal 170 receives the converted video/audio content via the femtocell access point 200, decodes the content, and then displays it.

As described above, the present invention allows the user to reproduce and display content, originally created for reproduction and display on a TV set, on the mobile terminal 170 via the femtocell access point 200 in the home 150.

While the exemplary embodiments of the present invention have been described, it is to be understood that the present invention is not limited to the exemplary embodiments described above and that further modifications, replacements, and adjustments may be added within the scope not departing from the basic technological concept of the present invention. For example, the IP network 135 in the exemplary embodiments described above may be not only a broadband network but an NGN (Next Generation Network) and the Internet.

If the mobile terminal 170 is capable of receiving an RTP stream, the gateway device may be configured in such a way that the transcoder unit 113 outputs a stream, not via the file conversion unit 114, but directly to the protocol conversion unit 115, the protocol conversion unit 115 converts the stream for processing by the RTP/UDP protocol, and the packet transmission unit 116 forwards the RTP/UDP/IP stream to the femtocell access point 200 by establishing a tunnel using the GTP-U protocol.

If a stream or a file read from the delivery server 190 is encrypted, the gateway device 110 may employ a configuration in which, when the stream is retrieved, the packet reception unit 112 decrypts the stream and then outputs the decrypted stream to the transcoder unit 113. In this case, the control signal conversion unit 111 of the gateway device 110 may be configured to obtain encryption/decryption information from the delivery server 190 of the service operator and, via the conversion instruction unit 117, notify the obtained encryption/decryption information to the packet reception unit 112.

Although moving-image content created by compression encoding a moving image signal is viewed in the first and second exemplary embodiments, the same effect may be achieved for a still image signal or an audio signal in the same configuration.

For the radio function of the mobile terminal 170, not only W-CDMA or CDMA2000 but HSDPA (High Speed Downlink Packet Access), HSPA+ (High Speed Packet Access), LTE (Long Term Evolution), or WiMAX may be used.

Although a mobile phone is used as the mobile terminal 170 in the first and second exemplary embodiments described above, not only a mobile phone but a PHS, a WiMAX terminal, a mobile data card stored notebook PC, and a mobile data card stored game machine may also be used.

As the femtocell access point 200, Home NodeB or Home eNodeB may also be used.

In the first and second exemplary embodiments described above, the gateway device 110 uses the terminal type information, described in the user agent header of an HTTP request command, to identify the machine type of the mobile terminal. Instead, the gateway device 110 may also interact with a mobile terminal to acquire the machine type information or the ability information. The machine type described above is not limited to the information in the narrow sense such as a model number but may be any information via which appropriate ability information can be extracted from the ability table 118.

In the following, preferred modes are summarized.

### Mode 1

A gateway device comprising:
a control signal conversion unit that accepts a stream or file request message from a mobile terminal via a femtocell access point and, after performing predetermined conversion, forwards the request message to a request destination;
an ability table that stores ability information on various types of mobile terminals;
a packet reception unit that receives a stream or a file from the request destination;
a conversion instruction unit that determines a way of conversion according to ability information on the mobile terminal of a request source by referencing said ability table;
a conversion unit that performs conversion for the stream or the file, received from the request destination, according to the way of conversion; and
a packet transmission unit that transmits the converted stream or file to said mobile terminal.

### Mode 2

The gateway device according to mode 1 wherein
the way of conversion include a conversion of at least one or more items of a codec, bit rate, screen resolution, frame rate, file format, and protocol.

### Mode 3

The gateway device according to mode 1 or 2 wherein
said conversion unit includes a transcoder unit that performs transcoding of the stream or the file.

### Mode 4

The gateway device according to mode 1 or 2 wherein
said conversion unit includes a file conversion unit that performs a file format conversion of the stream or file.

### Mode 5

The gateway device according to mode 1 or 2 wherein
said conversion unit includes a protocol conversion unit that performs protocol conversion.

### Mode 6

The gateway device according to any one of modes 1-5 wherein
said ability table stores ability information on at least two types of mobile terminals, the mobile terminals including a mobile phone, a PHS (Personal Handy-phone System), a WiMAX (Worldwide Interoperability for Microwave Access) terminal, a mobile data card built-in personal computer, and a mobile data card built-in game machine.

### Mode 7

The gateway device according to any one of modes 1-6 wherein
said ability table is a table that stores ability information on machine types of mobile terminals and
based on machine type information received from the mobile terminal, said conversion instruction unit acquires ability information on the mobile terminal from said ability table.

### Mode 8

The gateway device according to any one of modes 1-7 wherein
the gateway device accepts a stream or file request message from a mobile terminal via a Home NodeB or Home eNodeB, which function as the femtocell access point, and transmits a converted stream or file to the mobile terminal via the Home NodeB or Home eNodeB.

### Mode 9

A data relay method comprising:
accepting a stream or file request message from a mobile terminal via a femtocell access point and, after performing predetermined conversion, forwarding the request message to a request destination;
receiving a stream or a file from the request destination;
determining way of conversion according to ability information on the mobile terminal of a request source by referencing an ability table that stores ability information on various types of mobile terminals;
performing conversion for the stream or the file, received from the request destination, according to the way of conversion; and
transmitting the converted stream or file to said mobile terminal.

### Mode 10

The data relay method according to mode 9 wherein
as the way of conversion, a conversion of at least one or more items of a codec, bit rate, screen resolution, frame rate, file format, and protocol is performed.

### Mode 11

The data relay method according to mode 9 or 10 wherein
a transcoder unit that performs transcoding of the stream or the file is used for the conversion.

### Mode 12

The data relay method according to mode 9 or 10 wherein
a file conversion unit that performs a file format conversion of the stream or file is used for the conversion.

### Mode 13

The data relay method according to mode 9 or 10 wherein
a protocol conversion unit that performs protocol conversion is used for the conversion.

### Mode 14

The data relay method according to any one of modes 9-13 wherein
a table that stores ability information on at least two types of mobile terminals is used as said ability table, the mobile terminals including a mobile phone, a PHS (Personal Handy-phone System), a WiMAX (Worldwide Interoperability for Microwave Access) terminal, a mobile data card built-in personal computer, and a mobile data card built-in game machine.

### Mode 15

The data relay method according to any one of modes 9-14 wherein
machine type information is received from the mobile terminal and ability information corresponding to the machine type is acquired from the ability information, which stores ability information on machine types of mobile terminals, to determine the way of conversion.

### Mode 16

The data relay method according to any one of modes 9-15 wherein
the data relay method accepts a stream or file request message from a mobile terminal via a Home NodeB or Home eNodeB, which function as the femtocell access point, and transmits a converted stream or file to the mobile terminal via the Home NodeB or Home eNodeB.

The exemplary embodiments or examples may be changed and adjusted in the scope of the entire disclosure (including claims) of the present invention and based on the basic technological concept. In the scope of the claims of the present invention, various disclosed elements may be combined and selected in a variety of ways. That is, it is apparent that the present invention includes various modifications and changes that may be made by those skilled in the art according to the entire disclosure, including claims, and technological concepts thereof.

What is claimed is:

1. A gateway device, comprising:
a control signal conversion unit that accepts a stream or file request message from a mobile terminal via a femtocell access point and, after performing predetermined conversion, forwards the request message to a request destination;
an ability table that stores ability information on various types of mobile terminals;
a packet reception unit that receives a stream or a file from the request destination;
a conversion instruction unit that determines a way of conversion according to ability information on the mobile terminal of a request source by referencing said ability table;
a conversion unit that performs conversion for the stream or the file, received from the request destination, according to the way of conversion; and
a packet transmission unit that transmits the converted stream or file to said mobile terminal.

2. The gateway device according to claim 1, wherein
the way of conversion includes a conversion of at least one or more items of a codec, bit rate, screen resolution, frame rate, file format, and protocol.

3. The gateway device according to claim 1, wherein
said conversion unit includes a transcoder unit that performs transcoding of the stream or the file.

4. The gateway device according to claim 1, wherein
said conversion unit includes a file conversion unit that performs a file format conversion of the stream or file.

5. The gateway device according to claim 1, wherein
said conversion unit includes a protocol conversion unit that performs protocol conversion.

6. The gateway device as defined according to claim 1, wherein
said ability table stores ability information on at least two types of mobile terminals, the mobile terminals including a mobile phone, a PHS (Personal Handy-phone System), a WiMAX (Worldwide Interoperability for Microwave Access) terminal, a mobile data card built-in personal computer, and a mobile data card built-in game machine.

7. The gateway device according to claim 1, wherein
said ability table is a table that stores ability information on machine types of mobile terminals and
based on machine type information received from the mobile terminal, said conversion instruction unit acquires ability information on the mobile terminal from said ability table.

8. The gateway device according to claim 1, wherein
the gateway device accepts a stream or file request message from a mobile terminal via a Home NodeB or Home eNodeB, which functions as the femtocell access point, and transmits a converted stream or file to the mobile terminal via the Home NodeB or Home eNodeB.

9. A data relay method, comprising:
accepting a stream or file request message from a mobile terminal via a femtocell access point and, after performing predetermined conversion, forwarding the request message to a request destination;
receiving a stream or a file from the request destination;
determining way of conversion according to ability information on the mobile terminal of a request source by referencing an ability table that stores ability information on various types of mobile terminals;
performing conversion for the stream or the file, received from the request destination, according to the way of conversion; and
transmitting the converted stream or file to said mobile terminal.

10. The data relay method according to claim 9, wherein
as the way of conversion, a conversion of at least one or more items of a codec, bit rate, screen resolution, frame rate, file format, and protocol is performed.

11. The data relay method according to claim 9, wherein
a transcoder unit that performs transcoding of the stream or the file is used for the conversion.

12. The data relay method according to claim 9, wherein
a file conversion unit that performs a file format conversion of the stream or file is used for the conversion.

13. The data relay method according to claim 9, wherein
a protocol conversion unit that performs protocol conversion is used for the conversion.

14. The data relay method according to claim 9, wherein
a table that stores ability information on at least two types of mobile terminals is used as said ability table, the mobile terminals including a mobile phone, a PHS (Personal Handy-phone System), a WiMAX (Worldwide Interoperability for Microwave Access) terminal, a mobile data card built-in personal computer, and a mobile data card built-in game machine.

15. The data relay method according to claim 9, wherein
machine type information is received from the mobile terminal and ability information corresponding to the machine type is acquired from the ability information, which stores ability information on machine types of mobile terminals, to determine the way of conversion.

16. The data relay method according to claim 9, wherein
the data relay method accepts a stream or file request message from a mobile terminal via a Home NodeB or Home eNodeB, which function as the femtocell access point, and transmits a converted stream or file to the mobile terminal via the Home NodeB or Home eNodeB.

17. The gateway device according to claim 2, wherein
the way of conversion includes a conversion of at least one or more items of a codec, bit rate, screen resolution, frame rate, file format, and protocol.

18. The gateway device according to claim 2, wherein
said conversion unit includes a transcoder unit that performs transcoding of the stream or the file.

19. The gateway device according to claim 2, wherein
said conversion unit includes a file conversion unit that performs a file format conversion of the stream or file.

20. The gateway device according to claim 2, wherein
said conversion unit includes a protocol conversion unit that performs protocol conversion.
